(19) United States
(12) Patent Application Publication
(10) Pub. No.: US 2025/0330044 A1
(43) Pub. Date: Oct. 23, 2025

(54) SYSTEMS AND METHODS FOR REDUCING ENERGY CONSUMPTION OF A FACILITY BY SELECTIVELY SWITCHING OFF SMART ELECTRICAL SOCKETS

(71) Applicant: Honeywell International Inc., Charlotte, NC (US)

(72) Inventors: Bhupinder Heer, Harrow (GB); Neil Brown, Suffolk (GB); Philip Barnett, Essex (GB); Rajiv Singh, Bangalore (IN); Shyam Mohan Das, Rugby (GB); Vinoth Durairaj, Tamil Nadu (IN); Di Lin, Tianjin (CN); Wendy Guo, Tianjin (CN); Premkumar Gurusamy, Bangalore (IN)

(21) Appl. No.: 19/181,041

(22) Filed: Apr. 16, 2025

(30) Foreign Application Priority Data
Apr. 16, 2024 (IN) 202411030452

(51) Int. Cl. H02J 13/00; H02J 3/00

(52) U.S. Cl. CPC H02J 13/0005; H02J 3/0075; H02J 13/00022

(57) ABSTRACT

A system and method for controlling energy consumption in a facility region uses smart electrical sockets. The system includes smart electrical sockets with plug receptacles and socket controllers that can switch power on/off to the connected appliances. A supervisory controller connects to an occupancy sensor and the smart sockets. When the region becomes unoccupied for a threshold time, the controller signals selected sockets to switch off power to their connected appliances. When occupancy resumes, power may be automatically restored to selected sockets. Alternatively, or in addition, the system responds to demand response events by switching off power delivered by certain smart sockets, and automatically restoring power to selected sockets once the demand response event expires.

### RELATED APPLICATIONS

This application claims the benefit of Indian Provisional Application No. 202411030452, filed Apr. 16, 2024, which application is incorporated by reference herein.

### TECHNICAL FIELD

The present disclosure relates generally to connected power systems, and more particularly to reducing power consumption within a connected power system.

### BACKGROUND

Connected power systems include a number of smart sockets that can be centrally monitored and controlled. In some connected power systems, the smart sockets are connected to a source of power, and provide power to various electrical devices that are plugged into receptacles forming part of the smart sockets. The smart sockets report various operational parameters to a gateway device, and the gateway device communicates with a supervisory controller. The electrical devices plugged into each of the smart sockets can consume considerable electrical power. In some cases, these electrical devices may consume some power even when ostensibly turned off, sometimes referred to as parasitic electrical consumption. What would be desirable are methods and systems for reducing power consumption including parasitic electrical consumption.

### SUMMARY

The present disclosure relates generally to connected power systems, and more particularly to reducing power consumption within a connected power system. An example may be found in a system for controlling energy consumption of a region of a facility. The illustrative system includes an occupancy sensor for sensing an occupancy state of the region of the facility. The occupancy state may include an occupied state and an unoccupied state. The illustrative system includes one or more smart electrical sockets that are located in the region of the facility. Each of the smart electrical sockets include a plug receptacle for receiving a plug from a corresponding electrical appliance. Each of the one or more smart electrical sockets include a socket controller that is configured to control whether the corresponding smart electrical socket switches on power to the corresponding plug receptacle or switches off power to the corresponding plug receptacle. A supervisory controller is operatively coupled to the occupancy sensor and each of the one or more smart electrical sockets. In response to identifying that the occupancy state of the occupancy sensor switched from the occupied state to the unoccupied state and remains in the unoccupied state for at least a threshold period of time, the supervisory controller is configured to send a control signal to a first selected set of one or more of the smart electrical sockets that causes the corresponding socket controller to switch off power to the corresponding plug receptacle. In response to identifying that the occupancy state of the occupancy sensor switched from the unoccupied state to the occupied state, the supervisory controller is configured to send a control signal to a second selected set of one or more of the smart electrical sockets that causes the corresponding socket controller to switch on power to the corresponding plug receptacle.

Another example may be found in a system for controlling energy consumption of a region of a facility. The illustrative system includes an input for receiving a demand response signal indicating a demand response event applicable to the region of the facility (e.g. from a utility supplying electricity to the facility). One or more smart electrical sockets are located in the region of the facility, each having a plug receptacle for receiving a plug from a corresponding electrical appliance. Each of the one or more smart electrical sockets include a socket controller that is configured to control whether the corresponding smart electrical socket switches on power to the corresponding plug receptacle or switches off power to the corresponding plug receptacle. The illustrative system includes a supervisory controller that is operatively coupled to the input and each of the one or more smart electrical sockets. In response to receiving the demand response signal indicating a demand response event, the supervisory controller is configured to send a control signal to one or more of the smart electrical sockets that causes the corresponding socket controller to switch off power to the corresponding plug receptacle.

Another example may be found in a method for controlling energy consumption of a region of a facility. The illustrative method includes receiving an occupancy state of the region of the facility, wherein the occupancy state includes an occupied state and an unoccupied state. In response to identifying that the occupancy state of the region switched from the occupied state to the unoccupied state and remains in the unoccupied state for at least a threshold period of time, the illustrative method includes automatically switching power off to a corresponding plug receptacle of each of one or more smart electrical socket located in the region of the facility, wherein each plug receptacle is configured to receive a plug from a corresponding electrical appliance.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system for controlling energy consumption of a region of a facility;

FIG. 2 is a schematic block diagram showing an illustrative system for controlling energy consumption of a region of a facility; and

FIG. 3 is a flow diagram showing an illustrative method for controlling energy consumption of a region of a facility.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

In some instances, energy savings may be provided to a facility by selectively switching off smart electrical sockets of the facility. It will be appreciated that a facility may include a variety of different types of areas or rooms, and that this can influence how electricity is used throughout the facility. For example, some areas or rooms are frequently occupied throughout the day. Other areas or rooms are infrequently occupied. Some areas may be occupied for most time periods during business hours, but are not expected to be occupied during non-business hours such as overnight. In some cases, a system monitors the occupancy state of each region of the facility via one or more occupancy sensors, and automatically switches off selected smart electrical sockets in a region of the facility when the occupancy state of that region is determined to be unoccupied. When the region again becomes occupied, the system may automatically switch on selected smart electrical sockets in the region, In some cases, the one or more occupancy sensors are separate from the smart electrical sockets. In some cases, one or more of the smart electrical sockets may include an occupancy sensor.

In some cases, some smart electrical sockets may be excluded from being controlled. Examples include electrical sockets that provide power to refrigerators and freezers, electrical sockets intended for powering clocks, electrical sockets for some network equipment such as network copiers, fax machines, audio-visual equipment, data equipment such as servers.

In some cases, the system may monitors a demand response signal received from a utility, and in response to receiving a demand response signal that indicates a demand response event, the system may automatically switch off selected smart electrical sockets during the demand response event. When the demand response event has expired, the system may automatically switch on selected smart electrical sockets. In some cases, the system stores a programmable schedule, and automatically switches off selected smart electrical sockets in accordance with the schedule. In some cases, the system may control the smart electrical sockets in response to a detected occupancy state, a type of appliance plugged into each of the smart electrical sockets, a demand response event and/or a stored schedule, sometimes with a priority assigned to controlling based on each of the occupancy state, the type of the appliance, the demand response event and/or the stored schedule. For example, when the occupancy state (occupied, unoccupied) is recognized, the system may use the information, along with predetermined logic rules (including the stored schedule, the type of appliance, the current demand response status, and/or whether there is a manual override) with priority basis, to decide whether each of the smart electrical sockets should be switched On or off at any given time.

In some cases, once an occupancy state of unoccupied is determined for a region of a facility, sometimes for at least a predetermined period of time, the system may communicate with a building management system to implement energy-saving measures and/or certain security protocols. For example, the system may signal the HVAC system to enter an energy-saving mode by reducing temperature setpoints in the unoccupied region and/or command a security system to activate surveillance or lockdown procedures if an intrusion is suspected in an otherwise unoccupied region. Such a system may present several advantages, including energy efficiency, as controlling smart electrical sockets with integrated logic to decide to turn OFF/ON based on occupancy, demand response, type of connected appliance and/or schedule may result in significant energy savings. Also, by adjusting the BMS operations according to occupancy, demand response, type of connected appliance and/or schedule may result in significant energy savings. Additional advantages include security enhancement as security systems can be more responsive and tailored based on accurate occupancy information. The system may work without manual inputs, thereby reducing the need for human monitoring and intervention. The system is adaptable and can be implemented in various sizes and types of enterprises with multiple spatial hierarchies. The system can be applied to new constructions or retrofitted to existing infrastructures with minimal modifications.

In an example, a system for controlling energy consumption of a region of a facility includes an occupancy sensor for sensing an occupancy state of the region of the facility, wherein the occupancy state includes an occupied state and an unoccupied state. In this example, the system includes one or more smart electrical sockets located in the region of the facility each having a plug receptacle for receiving a plug from a corresponding electrical appliance, each of the one or more smart electrical sockets includes a socket controller that is configured to control whether the corresponding smart electrical socket switches on power to the corresponding plug receptacle or switches off power to the corresponding plug receptacle. The illustrative system includes a supervisory controller operatively coupled to the occupancy sensor and each of the one or more smart electrical sockets. In response to identifying that the occupancy state of the occupancy sensor switched from the occupied state to the unoccupied state, and remains in the unoccupied state for at least a threshold period of time, the supervisory controller is configured to send a control signal to a first selected set of one or more of the smart electrical sockets that causes the corresponding socket controller to switch off power to the corresponding plug receptacle. In response to identifying that the occupancy state of the occupancy sensor switched from the unoccupied state to the occupied state, the supervisory controller is configured to send a control signal to a second selected set of one or more of the smart electrical sockets that causes the corresponding socket controller to switch on power to the corresponding plug receptacle.

In some cases, the first selected set of one or more of the smart electrical sockets and the second selected set of one or more of the smart electrical sockets may be equal sets (i.e. correspond to the same set of smart electrical sockets). In some cases, the system may include a plurality of smart electrical sockets located in the region of the facility, and wherein the first selected set of one or more of the smart electrical sockets does not include all of the plurality of smart electrical sockets located in the region of the facility. In some cases, at least one of the plurality of smart electrical sockets located in the region of the facility does not have power switched off to the corresponding plug receptacle when the occupancy state of the occupancy sensor switches from the occupied state to the unoccupied state and remains in the unoccupied state for at least the threshold period of time.

In some cases, the supervisory controller may be operatively coupled to each of the one or more smart electrical sockets via a wireless connection. In some cases, the supervisory controller may be operatively coupled to each of the one or more smart electrical sockets via a hub (e.g. gateway) that is separate from the supervisory controller, wherein the hub is in wireless communication with each of the one or more smart electrical sockets. In some cases, each of the one or more smart electrical sockets may include a button that is operatively coupled to the corresponding socket controller, wherein when the button is manually activated by user, the corresponding socket controller causes the corresponding smart electrical socket to switch power on when power is currently powered off and/or to switch power off when power is currently powered on.

In some cases, the supervisory controller may be configured to receive a demand response signal to reduce energy consumption (e.g. from a utility), and in response, the supervisory controller may be configured to send a control signal to one or more of the smart electrical sockets that causes the corresponding socket controller to switch off power to the corresponding plug receptacle. In some cases, the supervisory controller may be configured to prioritize the demand response signal and send the control signal to one or more of the smart electrical sockets that causes the corresponding socket controller to switch off power to the corresponding plug receptacle even though the occupancy state of the occupancy sensor switches from the unoccupied state to the occupied state. In some cases, the supervisory controller may be configured to store a schedule, and control whether the one or more of the smart electrical sockets have power switched off to the corresponding plug receptacle or have power switched on to the corresponding plug receptacle according to the schedule. In some cases, the supervisory controller may be configured to prioritize controlling whether the one or more of the smart electrical sockets have power switched off to the corresponding plug receptacle or have power switched on to the corresponding plug receptacle in accordance with the occupancy state of the region over controlling in accordance with the schedule.

In another example, a system for controlling energy consumption of a region of a facility includes an input for receiving a demand response signal indicating a demand response event applicable to the region of the facility. One or more smart electrical sockets are located in the region of the facility each having a plug receptacle for receiving a plug from a corresponding electrical appliance. Each of the one or more smart electrical sockets includes a socket controller that is configured to control whether the corresponding smart electrical socket switches on power to the corresponding plug receptacle or switches off power to the corresponding plug receptacle. A supervisory controller is operatively coupled to the input receiving the demand response signal and each of the one or more smart electrical sockets. In response to receiving the demand response signal indicating a demand response event, the supervisory controller is configured to send a control signal to one or more of the smart electrical sockets that causes the corresponding socket controller to switch off power to the corresponding plug receptacle.

In some cases, in response to the demand response event expiring, the supervisory controller may be configured to send a control signal to one or more of the smart electrical sockets that causes the corresponding socket controller to switch on power to the corresponding plug receptacle. In some cases, each of the one or more smart electrical sockets may include a button that is operatively coupled to the corresponding socket controller, wherein when the button is manually activated by a user, the corresponding socket controller causes the corresponding smart electrical socket to switch power on when power is currently powered off and/or to switch power off when power is currently powered on, even during a demand response event.

In some cases, the system may include an occupancy sensor for sensing an occupancy state of the region of the facility, wherein the occupancy state includes an occupied state and an unoccupied state. The supervisory controller may be operatively coupled to the occupancy sensor. In response to identifying that the occupancy state of the occupancy sensor switched from the occupied state to the unoccupied state and remains in the unoccupied state for at least a threshold period of time, the supervisory controller may be configured to send a control signal to a first selected set of one or more of the smart electrical sockets that causes the corresponding socket controller to switch off power to the corresponding plug receptacle. In response to identifying that the occupancy state of the occupancy sensor switched from the unoccupied state to the occupied state, the supervisory controller may be configured to send a control signal to a second selected set of one or more of the smart electrical sockets that causes the corresponding socket controller to switch on power to the corresponding plug receptacle.

In another example, a method for controlling energy consumption of a region of a facility includes receiving an occupancy state of the region of the facility, wherein the occupancy state includes an occupied state and an unoccupied state. In response to identifying that the occupancy state of the region switched from the occupied state to the unoccupied state and remains in the unoccupied state for at least a threshold period of time, the method includes automatically switching power off to a corresponding plug receptacle of each of one or more smart electrical socket located in the region of the facility, wherein each plug receptacle is configured to receive a plug from a corresponding electrical appliance.

In some cases, in response to identifying that the occupancy state of the region switched from the unoccupied state to the occupied state, the method may include automatically switching power on to a corresponding plug receptacle of each of one or more smart electrical socket located in the region of the facility. In some cases, the method may include receiving a demand response signal indicating a demand response event applicable to the region of the facility. In response to receiving the demand response signal indicating the demand response event, the method may include automatically switching power off to a corresponding plug receptacle of each of one or more smart electrical socket located in the region of the facility. In some cases, in response to the demand response event expiring, the method may include automatically switching power on to a corresponding plug receptacle of each of one or more smart electrical socket located in the region of the facility.

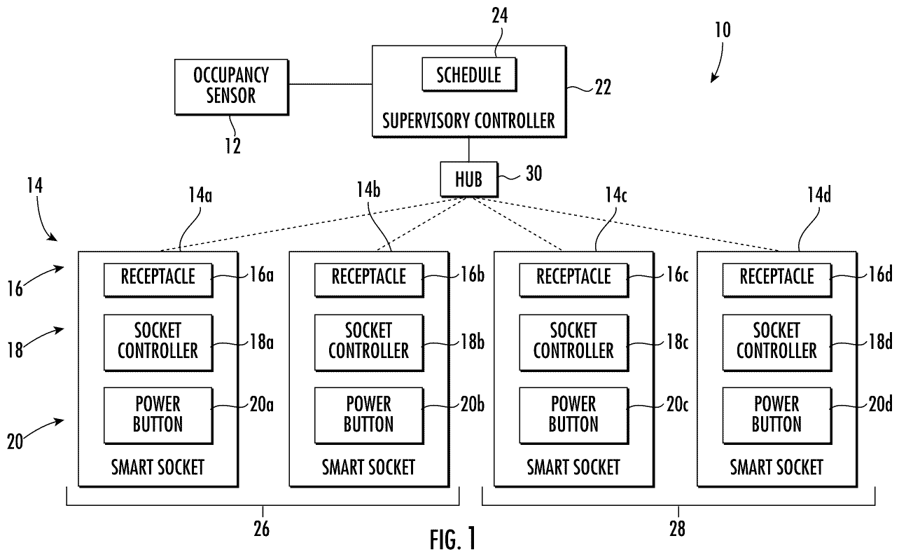

FIG. 1 is a schematic block diagram showing an illustrative system 10 for controlling energy consumption of a region or part of a facility. The illustrative system 10 includes an occupancy sensor 12 for sensing an occupancy state of the region of the facility. The occupancy sensor 12 may be a motion sensor such as a PIR (passive infrared) sensor, or any other suitable occupancy sensor. As an example, the occupancy state may include an occupied state and an unoccupied state. The system 10 includes one or more smart electrical sockets 14, individually labeled as 14a, 14b, 14c, and 14d. While a total of four smart electrical sockets 14 are shown, this is merely illustrative, as the system 10 may include any number of smart electrical sockets 14. Each of the smart electrical sockets 14 include a plug receptacle 16 (individually labeled as 16a, 16b, 16c, and 16d) for receiving a plug from a corresponding electrical appliance (not shown). Each of the smart electrical sockets 14 include a socket controller 18 (individually labeled as 18a, 18b, 18c, and 18d) that is configured to control whether the corresponding smart electrical socket 14 switches on power to the corresponding plug receptacle 16 or switches off power to the corresponding plug receptacle 16. In some cases, each of the smart electrical sockets 14 may include a power button 20 (individually labeled as 20a, 20b, 20c, and 20d) that may be used to manually turn on or turn off power to the corresponding plug receptacle 16. The power button 20 may be operatively coupled to the socket controller 18. In some cases, the supervisory controller 22 and/or hub 30 may control whether the corresponding smart electrical socket 14 switches on power to the corresponding plug receptacle 16 or switches off power to the corresponding plug receptacle 16, regardless of the state of the power button 20.

The illustrative system 10 includes a supervisory controller 22 that is operatively coupled to the occupancy sensor 12 and each of the smart electrical sockets 14. In some cases, the supervisory controller 22 stores a schedule 24 that the supervisory controller 22 may use in controlling when particular smart electrical sockets 14 are powered on and when particular smart electrical sockets 14 are powered off. In some cases, and in response to identifying that the occupancy state of the occupancy sensor 12 switched from the occupied state to the unoccupied state and remains in the unoccupied state for at least a threshold period of time, the supervisory controller 22 is configured to send a control signal to each of a first selected set 26 of the smart electrical sockets 14 that causes the corresponding socket controller 18 to switch off power to the corresponding plug receptacle 16. In response to identifying that the occupancy state of the occupancy sensor 12 switched from the unoccupied state to the occupied state, the supervisory controller 22 is configured to send a control signal to each of a second selected set 28 of the smart electrical sockets 14 that causes the corresponding socket controller 18 to switch on power to the corresponding plug receptacle 16. In some cases, each of the first selected set 26 and the second selected set 28 of smart electrical sockets 14 may include any number of smart electrical sockets 14. In some cases, the first selected set 26 of smart electrical sockets 14 and the second selected set 28 of smart electrical sockets 14 are equal sets (i.e. correspond to the same set of smart electrical sockets).

In some cases, the first selected set 26 of smart electrical sockets 14 does not include all of the smart electrical sockets 14 that are located in the region of the facility. In some cases, at least one of the smart electrical sockets 14 located in the region of the facility does not have power switched off to the corresponding plug receptacle 16 when the occupancy state of the occupancy sensor switches from the occupied state to the unoccupied state and remains in the unoccupied state for at least the threshold period of time. In some cases, the supervisory controller 22 may be operatively coupled to each of the one or more smart electrical sockets via a wireless connection. In some cases, the supervisory controller 22 may be operatively coupled to each of the smart electrical sockets 14 via a hub 30 (e.g. gateway) that is separate from the supervisory controller 22. The hub 30 may be in wireless communication with each of the smart electrical sockets 14.

In some cases, when the power button 20 for a particular smart electrical socket 14 is manually activated by user, the corresponding socket controller 18 may cause the corresponding smart electrical socket 14 to switch power on when power is currently powered off and/or to switch power off when power is currently powered on (e.g. toggle power ON/OFF). In some cases, the supervisory controller 22 may be configured to receive a demand response signal to reduce energy consumption, and in response, the supervisory controller 22 may be configured to send a control signal to one or more of the smart electrical sockets 14 that causes the corresponding socket controller 18 to switch off power to the corresponding plug receptacle 16, sometimes overriding the state of the power button 20. In some cases, the supervisory controller 22 may be configured to prioritize the demand response signal and send the control signal to one or more of the smart electrical sockets 14 that causes the corresponding socket controller 18 to switch off power to the corresponding plug receptacle 16 even though the occupancy state of the occupancy sensor 12 switches from the unoccupied state to the occupied state. In some cases, the supervisory controller 22 may be configured to prioritize certain appliance types over other appliance types when deciding which of the smart electrical sockets 14 to turn off during a demand response event. For example, higher power appliance that are deemed not critical at the moment can be prioritized to be turned off during the demand response event.

In some cases, the supervisory controller 22 may be configured to control whether the one or more of the smart electrical sockets 14 have power switched off to the corresponding plug receptacle 16 or have power switched on to the corresponding plug receptacle 16 according to the schedule 24 that is stored by the supervisory controller 22. In some cases, the supervisory controller 22 may be configured to prioritize controlling whether the one or more of the smart electrical sockets 14 have power switched off to the corresponding plug receptacle 16 or have power switched on to the corresponding plug receptacle 16 in accordance with the occupancy state of the region over controlling in accordance with the schedule 24. In some cases, the respective appliance type may also factor into the prioritization.

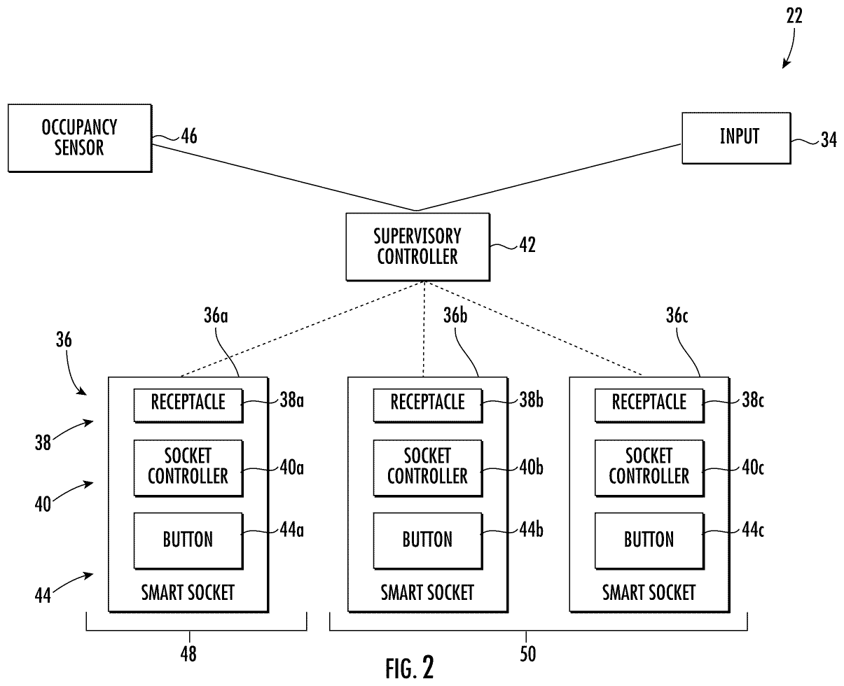

FIG. 2 is a schematic block diagram showing an illustrative system 32 for controlling energy consumption of a region of a facility. The illustrative system 32 may be considered as being an example of the illustrative system 10 shown in FIG. 1. The system 32 includes an input 34 for receiving a demand response signal indicating a demand response event applicable to the region of the facility. The system 32 includes one or more smart electrical sockets 36 (individually labeled as 36a, 36b, and 36c) that are located in the region of the facility. While a total of three smart electrical sockets 36 are shown, this is merely illustrative as the system 32 may include any number of smart electrical sockets 36. Each of the smart electrical sockets 36 include a plug receptacle 38 (individually labeled as 38a, 38b, and 38c) for receiving a plug from a corresponding electrical appliance (not shown). Each of the smart electrical sockets 36 includes a socket controller 40 (individually labeled as 40a, 40b, and 40c) that is configured to control whether the corresponding smart electrical socket 36 switches on power to the corresponding plug receptacle 38 or switches off power to the corresponding plug receptacle 38. A supervisory controller 42 is operatively coupled to the input 34 and each of the smart electrical sockets 36 (sometimes through a hub or gateway as in FIG. 1). In response to receiving the demand response signal indicating a demand response event, the supervisory controller 42 is configured to send a control signal to one or more of the smart electrical sockets 36 that causes the corresponding socket controller 40 to switch off power to the corresponding plug receptacle 38.

In some cases, and in response to the demand response event expiring, the supervisory controller 42 may be configured to send a control signal to one or more of the smart electrical sockets 36 that causes the corresponding socket controller 40 to switch on power to the corresponding plug receptacle 38. In some cases, each of the smart electrical sockets 36 may include a button 44 (individually labeled as 44a, 44b, and 44c) that is operatively coupled to the corresponding socket controller 40. When the button 44 is manually activated by user, the corresponding socket controller 40 causes the corresponding smart electrical socket 36 to switch power on when power is currently powered off and/or to switch power off when power is currently powered on, even during a demand response event. In some cases, when the button 44 is manually activated by user, the corresponding socket controller 40 causes the corresponding smart electrical socket 36 to switch power on when power is currently powered off for a predetermined period of time, before again automatically switching power off. In some cases, the manual switch may be deactivated during a demand response event, preventing the user from manually turning on the respective appliance during a demand response event.

In some cases, the system 32 may include an occupancy sensor 46 for sensing an occupancy state of the region of the facility. The occupancy state includes an occupied state and an unoccupied state, for example. In some cases, the occupancy sensor 46 may be a motion sensor. In some cases, the occupancy sensor 46 may provide a signal to the supervisory controller 42, providing an indication of the occupancy state of the region of the facility. In response to identifying that the occupancy state of the occupancy sensor 46 switched from the occupied state to the unoccupied state, and remains in the unoccupied state for at least a threshold period of time, the supervisory controller 42 may be configured to send a control signal to a first selected set 48 of one or more smart electrical sockets 36 that causes the corresponding socket controller 40 to switch off power to the corresponding plug receptacle 38. In response to identifying that the occupancy state of the occupancy sensor 46 switched from the unoccupied state to the occupied state, the supervisory controller 42 may be configured to send a control signal to a second selected set 50 of one or more smart electrical sockets 36 that causes the corresponding socket controller 40 to switch on power to the corresponding plug receptacle 38.

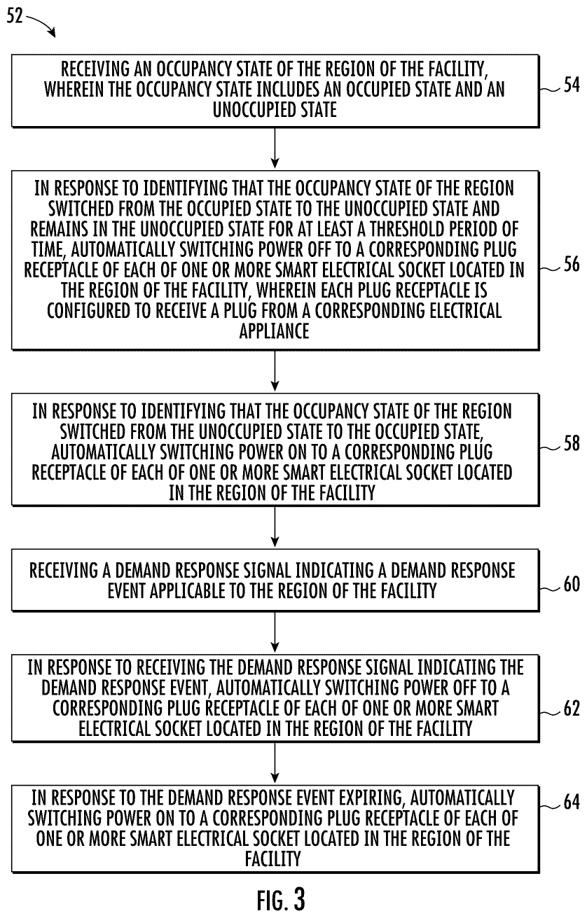

FIG. 3 is a flow diagram showing an illustrative method 52 for controlling energy consumption of a region of a facility. The method 52 includes receiving an occupancy state of the region of the facility, wherein the occupancy state includes an occupied state and an unoccupied state, as indicated at block 54. In response to identifying that the occupancy state of the region switched from the occupied state to the unoccupied state, and remains in the unoccupied state for at least a threshold period of time, power is automatically switched off to a corresponding plug receptacle of each of one or more smart electrical socket located in the region of the facility, wherein each plug receptacle is configured to receive a plug from a corresponding electrical appliance, as indicated at block 56.

In some cases, the method 52 may include, in response to identifying that the occupancy state of the region switched from the unoccupied state to the occupied state, automatically switching power on to a corresponding plug receptacle of each of one or more smart electrical socket located in the region of the facility, as indicated at block 58. In some cases, the method 52 may include receiving a demand response signal indicating a demand response event applicable to the region of the facility, as indicated at block 60. In response to receiving the demand response signal indicating the demand response event, the method 52 may include automatically switching power off to a corresponding plug receptacle of each of one or more smart electrical socket located in the region of the facility, as indicated at block 62. In some cases, and in response to the demand response event expiring, the method 52 may include automatically switching power on to a corresponding plug receptacle of each of one or more smart electrical socket located in the region of the facility.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A system for controlling energy consumption of a region of a facility, the system comprising:
an occupancy sensor for sensing an occupancy state of the region of the facility, wherein the occupancy state includes an occupied state and an unoccupied state;
one or more smart electrical sockets located in the region of the facility each having a plug receptacle for receiving a plug from a corresponding electrical appliance, each of the one or more smart electrical sockets includes a socket controller that is configured to control whether the corresponding smart electrical socket switches on power to the corresponding plug receptacle or switches off power to the corresponding plug receptacle;
a supervisory controller operatively coupled to the occupancy sensor and each of the one or more smart electrical sockets, wherein:
in response to identifying that the occupancy state of the occupancy sensor switched from the occupied state to the unoccupied state and remains in the unoccupied state for at least a threshold period of time, the supervisory controller is configured to send a control signal to a first selected set of one or more of the smart electrical sockets that causes the corresponding socket controller to switch off power to the corresponding plug receptacle; and
in response to identifying that the occupancy state of the occupancy sensor switched from the unoccupied state to the occupied state, the supervisory controller is configured to send a control signal to a second selected set of one or more of the smart electrical sockets that causes the corresponding socket controller to switch on power to the corresponding plug receptacle.

2. The system of claim 1, wherein the first selected set of one or more of the smart electrical sockets and the second selected set of one or more of the smart electrical sockets are equal sets.

3. The system of claim 1, comprising a plurality of smart electrical sockets located in the region of the facility, and wherein the first selected set of one or more of the smart electrical sockets does not include all of the plurality of smart electrical sockets located in the region of the facility.

4. The system of claim 3, wherein at least one of the plurality of smart electrical sockets located in the region of the facility does not have power switched off to the corresponding plug receptacle when the occupancy state of the occupancy sensor switches from the occupied state to the unoccupied state and remains in the unoccupied state for at least the threshold period of time.

5. The system of claim 1, wherein the supervisory controller is operatively coupled to each of the one or more smart electrical sockets via a wireless connection.

6. The system of claim 1, wherein the supervisory controller is operatively coupled to each of the one or more smart electrical sockets via a hub that is separate from the supervisory controller, wherein the hub is in wireless communication with each of the one or more smart electrical sockets.

7. The system of claim 1, wherein each of the one or more smart electrical sockets includes a button that is operatively coupled to the corresponding socket controller, wherein when the button is manually activated by user, the corresponding socket controller causes the corresponding smart electrical socket to switch power on when power is currently powered off and/or to switch power off when power is currently powered on.

8. The system of claim 7, wherein the supervisory controller is configured to receive a demand response signal to reduce energy consumption, and in response, the supervisory controller is configured to send a control signal to one or more of the smart electrical sockets that causes the corresponding socket controller to switch off power to the corresponding plug receptacle.

9. The system of claim 8, wherein the supervisory controller is configured to prioritize the demand response signal and send the control signal to one or more of the smart electrical sockets that causes the corresponding socket controller to switch off power to the corresponding plug receptacle even though the occupancy state of the occupancy sensor switches from the unoccupied state to the occupied state.

10. The system of claim 1, wherein the supervisory controller is configured to store a schedule, and control whether the one or more of the smart electrical sockets have power switched off to the corresponding plug receptacle or have power switched on to the corresponding plug receptacle according to the schedule.

11. The system of claim 10, wherein the supervisory controller is configured to prioritize controlling whether the one or more of the smart electrical sockets have power switched off to the corresponding plug receptacle or have power switched on to the corresponding plug receptacle in accordance with the occupancy state of the region over controlling in accordance with the schedule.

12. A system for controlling energy consumption of a region of a facility, the system comprising:
an input for receiving a demand response signal indicating a demand response event applicable to the region of the facility;
one or more smart electrical sockets located in the region of the facility each having a plug receptacle for receiving a plug from a corresponding electrical appliance, each of the one or more smart electrical sockets includes a socket controller that is configured to control whether the corresponding smart electrical socket switches on power to the corresponding plug receptacle or switches off power to the corresponding plug receptacle; and
a supervisory controller operatively coupled to the input and each of the one or more smart electrical sockets, wherein:
in response to receiving the demand response signal indicating a demand response event, the supervisory controller is configured to send a control signal to one or more of the smart electrical sockets that causes the corresponding socket controller to switch off power to the corresponding plug receptacle.

13. The system of claim 12, wherein in response to the demand response event expiring, the supervisory controller is configured to send a control signal to one or more of the smart electrical sockets that causes the corresponding socket controller to switch on power to the corresponding plug receptacle.

14. The system of claim 12, wherein each of the one or more smart electrical sockets includes a button that is operatively coupled to the corresponding socket controller, wherein when the button is manually activated by user, the corresponding socket controller causes the corresponding smart electrical socket to switch power on when power is currently powered off and/or to switch power off when power is currently powered on, even during a demand response event.

15. The system of claim 12, wherein each of the one or more smart electrical sockets includes a button that is operatively coupled to the corresponding socket controller, wherein when the button is manually activated by user, the corresponding socket controller causes the corresponding smart electrical socket to switch power on when power is currently powered off for a predetermined period of time before automatically switching power off.

16. The system of claim 12, comprising:
an occupancy sensor for sensing an occupancy state of the region of the facility, wherein the occupancy state includes an occupied state and an unoccupied state;
the supervisory controller is operatively coupled to the occupancy sensor, wherein:
in response to identifying that the occupancy state of the occupancy sensor switched from the occupied state to the unoccupied state and remains in the unoccupied state for at least a threshold period of time, the supervisory controller is configured to send a control signal to a first selected set of one or more of the smart electrical sockets that causes the corresponding socket controller to switch off power to the corresponding plug receptacle; and
in response to identifying that the occupancy state of the occupancy sensor switched from the unoccupied state to the occupied state, the supervisory controller is configured to send a control signal to a second selected set of one or more of the smart electrical sockets that causes the corresponding socket controller to switch on power to the corresponding plug receptacle.

17. A method for controlling energy consumption of a region of a facility, comprising:
receiving an occupancy state of the region of the facility, wherein the occupancy state includes an occupied state and an unoccupied state; and
in response to identifying that the occupancy state of the region switched from the occupied state to the unoccupied state and remains in the unoccupied state for at least a threshold period of time, automatically switching power off to a corresponding plug receptacle of each of one or more smart electrical socket located in the region of the facility, wherein each plug receptacle is configured to receive a plug from a corresponding electrical appliance.

18. The method of claim 17, comprising:
in response to identifying that the occupancy state of the region switched from the unoccupied state to the occupied state, automatically switching power on to a corresponding plug receptacle of each of one or more smart electrical socket located in the region of the facility.

19. The method of claim 17, comprising:
receiving a demand response signal indicating a demand response event applicable to the region of the facility; and
in response to receiving the demand response signal indicating the demand response event, automatically switching power off to a corresponding plug receptacle of each of one or more smart electrical socket located in the region of the facility.

20. The method of claim 19, comprising:
in response to the demand response event expiring, automatically switching power on to a corresponding plug receptacle of each of one or more smart electrical socket located in the region of the facility.
